(19) United States
(12) Patent Application Publication
(10) Pub. No.: US 2019/0263124 A1
(43) Pub. Date: Aug. 29, 2019

(54) LIQUID EJECTION HEAD SUBSTRATE AND METHOD FOR PRODUCING LIQUID EJECTION HEAD SUBSTRATE

(71) Applicant: CANON KABUSHIKI KAISHA, Tokyo (JP)

(72) Inventors: Kenji Takahashi, Yokohama-shi (JP); Mitsuru Chida, Yokohama-shi (JP); Mitsunori Toshishige, Kawasaki-shi (JP); Shiro Sujaku, Kawasaki-shi (JP); Kenji Kumamaru, Urayasu-shi (JP); Noriyasu Ozaki, Atsugi-shi (JP); Makoto Terui, Yokohama-shi (JP); Seiko Minami, Warabi-shi (JP)

(21) Appl. No.: 16/280,493

(22) Filed: Feb. 20, 2019

(30) Foreign Application Priority Data
Feb. 28, 2018 (JP) 2018-034903

(51) Int. Cl. B41J 2/16

(52) U.S. Cl. CPC B41J 2/1634; B41J 2/162; B41J 2/1642; B41J 2/1626; B41J 2/1606

(57) ABSTRACT

A liquid ejection head substrate that includes a nozzle plate provided with an ejection orifice adapted to eject liquid droplets, in which a projection/depression pattern is provided on a liquid droplet ejection surface of the nozzle plate, the projection/depression pattern being made up of a plurality of projections and depressions, the projections being separated by depressions 1 μm or less in depth and disposed at predetermined spacing 10 μm or less in length; and the projection/depression pattern includes a part having water repellency due to lotus effect.

### BACKGROUND OF THE INVENTION

### Field of the Invention

The present invention relates to a liquid ejection head substrate that ejects liquid droplets such as ink through ejection orifices as well as to a method for producing the liquid ejection head substrate.

### Description of the Related Art

In recent years, there has been demand for higher print quality and there is strong demand for improvement in ejection performance of liquid ejection head substrates such as ink jet recording substrates adapted to eject ink using an ink jet technique. For example, if ink attaches to a neighborhood of ejection orifices provided in an ink jet recording substrate, a traveling direction of the ejected ink may become unsettled. Therefore, water repellent treatment is applied to a liquid droplet ejection surface of a nozzle plate in which ejection orifices are formed.

According to Japanese Patent Application Laid-Open No. 2009-107314, a diamond-like carbon (hereinafter also referred to as “DLC”) film that has excellent wear resistance and high resistance against acid solutions and alkaline solutions is formed on the liquid droplet ejection surface of a nozzle plate and projections and depressions are formed on a surface of the DLC film by a rubbing or other technique. The projections and depressions formed on the surface of the DLC film structurally act to exhibit water repellency. Consequently, it is supposed that the nozzle plate disclosed in Japanese Patent Application Laid-Open No. 2009-107314 can maintain stable water repellency for an extended period of time.

### SUMMARY OF THE INVENTION

A liquid ejection head substrate according to the present invention comprises a nozzle plate provided with nozzle holes adapted to eject liquid droplets; and a projection/depression pattern made up of minute projections and minute depressions disposed alternately at predetermined spacing on a liquid droplet ejection surface of the nozzle plate.

That is, the present invention provides a liquid ejection head substrate comprising a nozzle plate provided with an ejection orifice adapted to eject liquid droplets, wherein: a projection/depression pattern is provided on a liquid droplet ejection surface of the nozzle plate, the projection/depression pattern being made up of a plurality of projections and depressions, the projections being separated by depressions 1 μm or less in depth and disposed at predetermined spacing 10 μm or less in length; and the projection/depression pattern includes a part having water repellency due to lotus effect.

Also, according to another aspect of the present invention, there is provided a method for producing a liquid ejection head substrate that includes a nozzle plate provided with an ejection orifice adapted to eject liquid droplets, the method comprising emitting a linearly-polarized laser to a liquid droplet ejection surface of the nozzle plate at irradiation intensity in a neighborhood of a processing threshold and thereby forming a projection/depression pattern in a self-organizing manner on the liquid droplet ejection surface of the nozzle plate, the projection/depression pattern being made up of projections and depressions disposed alternately at predetermined spacing.

Further features of the present invention will become apparent from the following description of exemplary embodiments with reference to the attached drawings.

### BRIEF DESCRIPTION OF THE DRAWINGS

FIG. 1 is a perspective view of a liquid ejection head according to an embodiment of the present invention.

FIG. 2 is a perspective view of a liquid ejection head substrate according to the embodiment of the present invention.

FIG. 3 is a schematic sectional view of the liquid ejection head substrate according to the embodiment of the present invention.

FIG. 4A is a process sectional view illustrating a method for producing the liquid ejection head substrate according to the embodiment of the present invention.

FIG. 4B is a process sectional view illustrating the method for producing the liquid ejection head substrate according to the embodiment of the present invention.

FIG. 4C is a process sectional view illustrating the method for producing the liquid ejection head substrate according to the embodiment of the present invention.

FIG. 4D is a process sectional view illustrating the method for producing the liquid ejection head substrate according to the embodiment of the present invention.

FIG. 5A is sectional view showing a variation in which a water-repellent layer is formed on a nozzle plate in the liquid ejection head substrate according to the embodiment of the present invention.

FIG. 5B is sectional view showing a variation in which a water-repellent layer is formed on the nozzle plate in the liquid ejection head substrate according to the embodiment of the present invention.

FIG. 6A is a schematic diagram showing a state of an ink droplet on the nozzle plate according to the embodiment of the present invention.

FIG. 6B is a schematic diagram showing a state of an ink droplet on the nozzle plate according to the embodiment of the present invention.

FIG. 7A is perspective view illustrating a projection/depression structure on a nozzle plate surface according to the embodiment of the present invention.

FIG. 7B is perspective view illustrating a projection/depression structure on the nozzle plate surface according to the embodiment of the present invention.

FIG. 8A is plan view showing formation of regions differing in water repellency in a neighborhood of an ejection orifice in the liquid ejection head substrate according to the embodiment of the present invention.

FIG. 8B is plan view showing formation of regions differing in water repellency in a neighborhood of an ejection orifice in the liquid ejection head substrate according to the embodiment of the present invention.

FIG. 9A is plan view showing formation of regions differing in water repellency in a neighborhood of ejection orifices in the liquid ejection head substrate according to the embodiment of the present invention.

FIG. 9B is plan view showing formation of regions differing in water repellency in a neighborhood of ejection orifices in the liquid ejection head substrate according to the embodiment of the present invention.

FIG. 10 is a completed sectional view of the liquid ejection head substrate according to the embodiment of the present invention.

FIG. 11 is a completed sectional view of the liquid ejection head substrate according to the embodiment of the present invention.

FIG. 12 is a diagram illustrating a relationship between an orientation of grooves in the projection/depression structure on the nozzle plate and a wiping direction.

### DESCRIPTION OF THE EMBODIMENTS

Preferred embodiments of the present invention will now be described in detail in accordance with the accompanying drawings.

A liquid droplet ejection surface of a nozzle plate of an ink jet recording substrate gradually decreases in water repellency with use due to chemical impact caused by contact with ink or due to physical wear caused by wiping of adherent ink droplets. When a water-repellent layer is formed by the method described in Japanese Patent Application Laid-Open No. 2009-107314, spacing and depth of a projection/depression structure formed by rubbing are irregular. Therefore, the extent of decrease in water repellency with the use of the ink jet recording substrate varies with the place on the nozzle plate. Consequently, there is a problem in that unintended variations occur in water repellency on the nozzle plate, making a liquid droplet ejection direction unsettled.

The present invention has been made in view of the conventional technique described above and has an object to provide a liquid ejection head substrate on which spacing and depth of a projection/depression structure on a liquid droplet ejection surface of a nozzle plate are uniform as well as to provide a method for producing the liquid ejection head substrate.

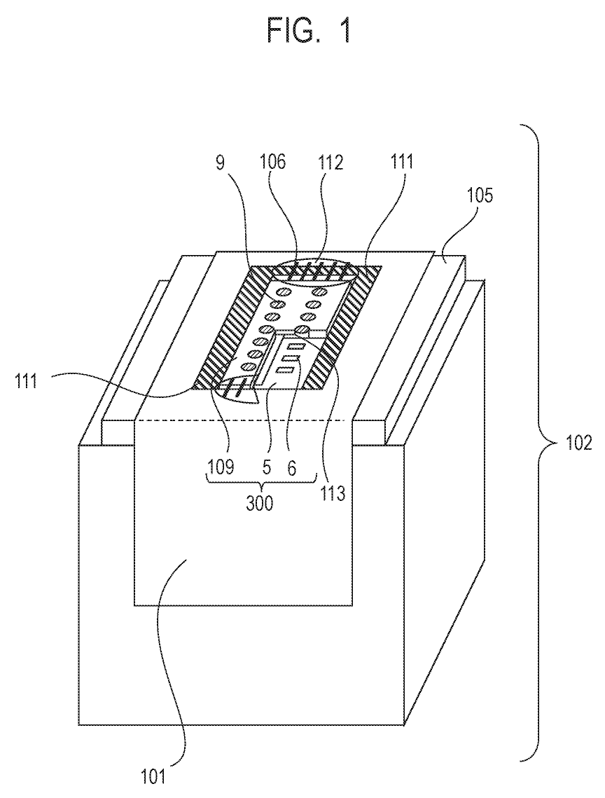

FIG. 1 is a perspective view of a liquid ejection head according to an embodiment of the present invention. The liquid ejection head according to the present invention is applicable to a printer, a copier, a facsimile machine equipped with a communications system, a device such as a word processor equipped with a printer unit as well as to an industrial recorder compositely combined with various processing units. For example, the liquid ejection head can be used in applications such as biochip fabrication or electronic circuit printing. Also, the embodiment described below is an appropriate concrete example of the present invention and various technically preferable limitations are placed thereon. However, as long as the idea of the present embodiment is followed, the present invention is not limited to the embodiment described herein or any other specific method. Whereas an ink jet head adapted to eject ink using an ink jet technique will be described below as an example, the present invention is not limited to this and is generally applicable to liquid ejection heads that need wiping and the like to remove liquid droplets attaching to nozzle plates. Also, the liquid ejection head substrate will be described below as an ink jet recording substrate.

An ink jet head 102 includes an ink jet recording substrate 300 and a substrate perimeter sealant serving as a sealing member 111 provided around a base 5, which is part of the ink jet recording substrate. The ink jet recording substrate 300 includes the base 5 provided with plural energy generating elements 6 adapted to generate energy used to eject a liquid and an ejection orifice member 109 provided with ejection orifices 9 corresponding to the elements. Furthermore, a flow path 113 is provided by being communicated with the ejection orifices 9. The ink jet recording substrate 300 is supported and fixed by a supporting member 105. Also, the sealing member 111 is provided on an outer periphery of the base 5 in contact with at least part of end faces, which are side faces of the substrate. This enables preventing a liquid or the like from coming into contact with the end faces, which are the side faces of the substrate. Also, the sealing member 111 is in contact with the supporting member 105. The ink jet recording substrate 300 and an electric wiring member 101 are connected with each other via lead wires 106 and the lead wires 106 are sealed by a lead sealing member 112.

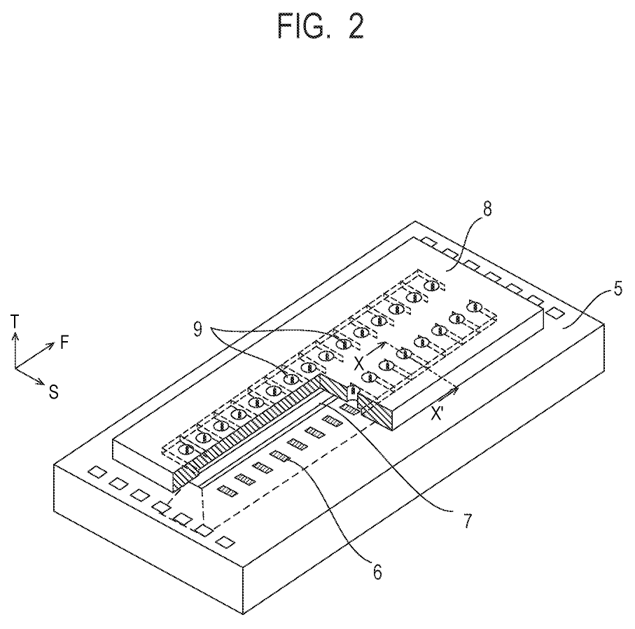

FIG. 2 is a perspective view of the ink jet recording substrate according to the embodiment of the present invention.

On the base 5, energy generating elements 6 used to foam ink and a drive circuit (not shown) adapted to drive the energy generating elements 6 are formed on a silicon substrate using semiconductor producing technology. Also, to communicate between that surface on the base 5 on which the energy generating elements 6 are formed and an undersurface on the opposite side, a supply port 7 is formed penetrating the base 5. Furthermore, the ejection orifices 9 used to eject ink supplied from an underside of the substrate by a nozzle forming member 8 are formed above the energy generating elements 6. The ink is foamed by driving the energy generating elements 6 corresponding to the ejection orifices 9, and using pressure of the foaming, ink is ejected to do printing. Whereas FIG. 2 shows a configuration in which two rows of ejection orifices are formed, this is not restrictive, and less than or more than two rows may be placed. Also, a direction in which the ejection orifices are arranged is referred to as a first direction F, a direction orthogonal thereto is referred to as a second direction S, and a direction perpendicular to a substrate surface is referred to as a third direction T.

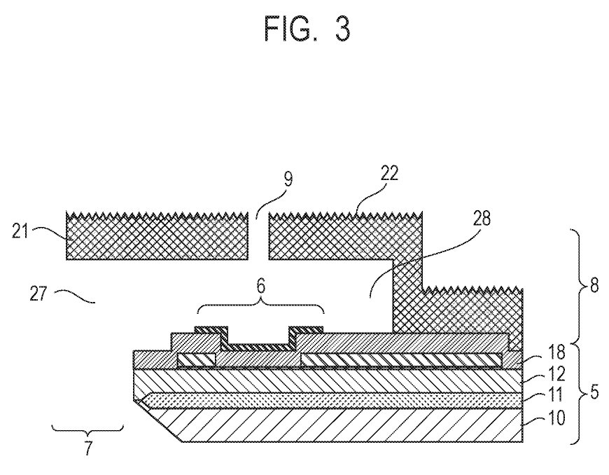

Next, a method for producing the ink jet recording substrate according to the present embodiment will be described. FIG. 3 is a sectional view of the ink jet recording substrate taken along line X-X′ in FIG. 2.

The base 5 is made up of various layers formed on a substrate 10 of silicon or the like and the energy generating elements 6 corresponding to the ejection orifices 9 are formed thereon. The nozzle forming member 8 is also referred to as a nozzle plate 21. A projection/depression pattern 22 made up of plural projections separated by depressions 1 μm or less in depth and disposed at predetermined spacing 10 μm or less in length is formed on a liquid droplet ejection surface, which is an outermost surface of the nozzle plate 21. Also, the projection/depression pattern includes a part having water repellency due to lotus effect.

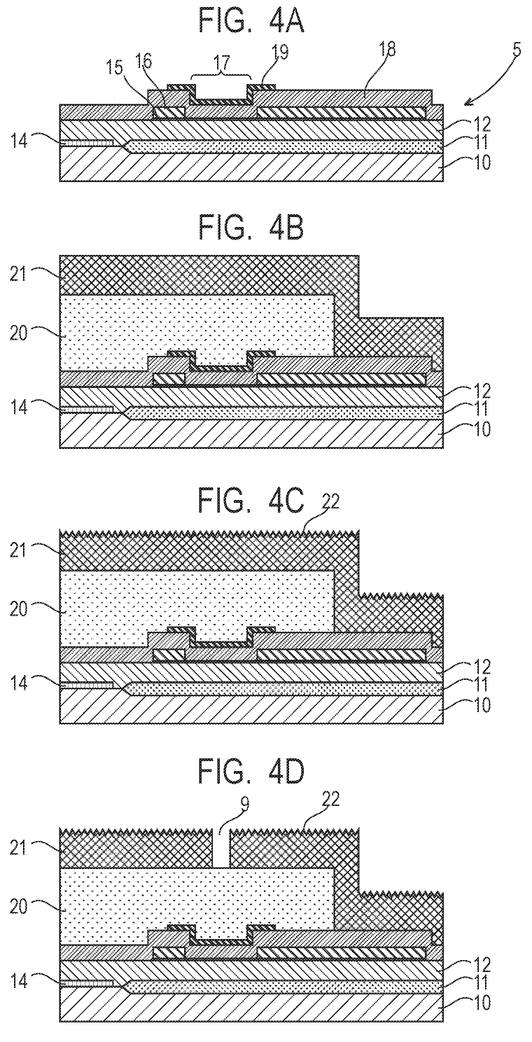

Steps of producing the ink jet recording substrate will be described below with reference to FIGS. 4A to 4D. FIGS. 4A to 4D show the same cross section as FIG. 3.

First, the base 5 such as shown in FIG. 4A is prepared. A thermally-oxidized layer 11 formed by thermally-oxidizing part of the Si substrate 10 and a heat accumulating layer 12 are provided on the Si substrate 10 on which driving elements such as transistors (not shown) are provided. Thickness of the thermally-oxidized layer 11 can be between 500 nm and 2000 nm (both inclusive). The heat accumulating layer 12 is formed of a silicon compound prepared, for example, by plasma CVD or the like and can be between 500 nm and 2000 nm (both inclusive) in thickness. Also, a sacrificial layer 14 made of aluminum or the like and used in forming the supply port 7 is formed on the Si substrate 10. A resistor layer 15 is formed on the heat accumulating layer 12. The resistor layer 15 is formed of a material that generates heat when an electric current is passed therethrough. Examples of such materials include TaSiN and WSiN. Sheet resistance of the resistor layer 15 can be between 100 Ω/sq and 1000 Ω/sq (both inclusive). Electrode layers 16 lower in resistance than the resistor layer 15 are formed on the resistor layer 15. The electrode layers 16 are formed, for example, of aluminum, and is between 100 nm and 2000 nm (both inclusive) in thickness. A pair of the electrode layers 16 are provided, and the resistor layer 15 exposed between the pair of electrode layers 16 is a heat generating resistor 17 serving as the energy generating elements 6. That is, part of the resistor layer 15 makes up the heat generating resistor 17. When a voltage is applied to the pair of electrode layers 16, the heat generating resistor 17 generates heat. The heat generating resistor 17 and electrode layers 16 are coated continuously with a coating layer 18. Here, the coating layer 18 is an insulating layer formed of SiN. The coating layer 18 insulates the heat generating resistor 17 and electrode layers 16 from an ejected liquid (ink). Subsequently, a protective layer 19 made of Ta or the like is formed on the heat generating resistor 17 as needed. The protective layer 19 functions as a cavitation film adapted to dampen a shock caused when foam disappears after the liquid is foamed by being heated by the heat generating resistor 17.

Next, as shown in FIG. 4B, a mold 20 designed to become a pattern for the flow path is provided, covering the heat generating resistor 17. The mold 20 is formed, for example, of a resin. When the resin is a photosensitive resin, the photosensitive resin can be applied onto a substrate, exposed, and developed followed by patterning, to prepare the mold 20 designed to become a pattern for the flow path. When the resin is not a photosensitive resin, possible methods include a method that involves providing a photosensitive resin on the resin of a mold, forming a resist mask by patterning the photosensitive resin, and etching the resin by ME (Reactive-Ion Etching) or the like using a resist mask. Also, the mold 20 is not limited to a resin, and may be formed of aluminum or other metal. When aluminum is used possible methods include a method that involves forming a film of aluminum on the substrate 10 by sputtering, forming a resist mask of a photosensitive resin or the like on the aluminum, and etching the aluminum by ME or the like using a resist mask. Next, the mold 20 is covered and a layer designed to become the nozzle plate 21 is formed on the base 5.

Any publicly-known material can be used for the nozzle plate 21, but desirably the material is an inorganic material processible by plasma CVD. Also, the nozzle plate 21 is not limited to a single layer, and may be multi-layered. In particular, desirably the liquid droplet ejection surface designed to become the outermost surface of the nozzle plate is made of a water-repellent material.

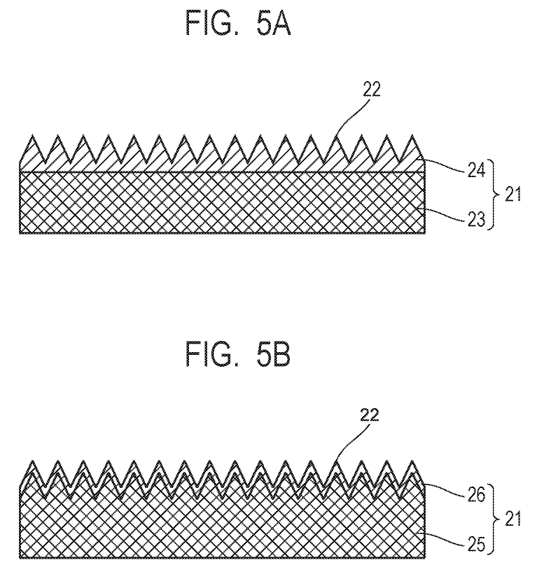

For example, as shown in FIG. 5A, the nozzle plate 21 may have a laminated structure made up of a non-water-repellent substrate layer 23 and a water-repellent layer 24, and the projection/depression pattern 22 may be provided on the water-repellent layer 24. When the material itself of the nozzle plate 21 has water repellency, there is no need to additionally provide a water-repellent layer. Also, as shown in FIG. 5B, after being formed on a non-water-repellent substrate layer 25, the projection/depression pattern 22 may be covered with a water-repellent layer 26 along its profile. This configuration allows advantageous effects of the present invention to be achieved even when the material itself of the nozzle plate 21 is not water-repellent. A fluorine resin or fluoridated DLC can be used for the water repellent layer. Available methods for forming the water repellent layer include liquid phase methods such as application, and gas phase methods such as sputtering and vacuum evaporation. Note that according to the present invention, a water contact angle of 90 degrees or above means water repellency and a water contact angle of less than 90 means no water repellency. Also, of water repellency, a water contact angle of 135 degrees or above means high water repellency.

The layer designed to become the nozzle plate 21 can be formed on the coating layer 18 and on any protective layer 19 as well by being extended on top of the mold 20. Note that the nozzle plate is a nozzle forming member in which ejection orifices are formed. Desirably thickness of the nozzle plate on the mold 20 is between 1 μm and 100 μm (both inclusive). More desirably, the thickness is 2 μm or above, and still more desirably 5 μm or above. The nozzle plate is prepared in this way.

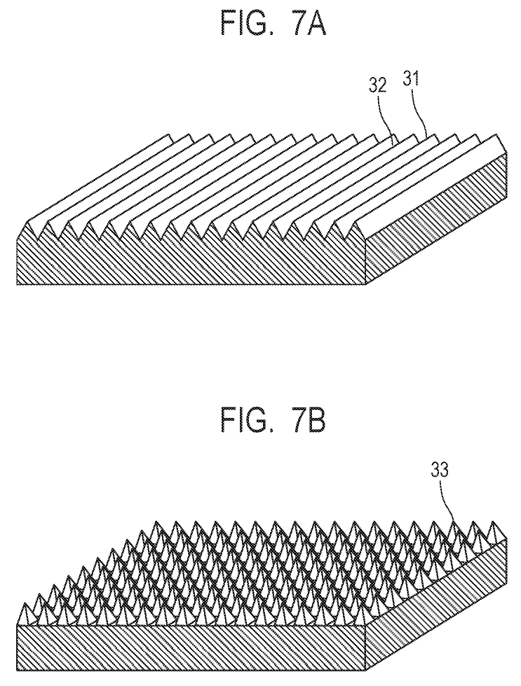

Next as shown in FIG. 4C, the projection/depression pattern 22 made up of plural projections separated by depressions is formed on a nozzle plate surface. Note that the projection/depression pattern 22 is shown by being enlarged to appear larger than actual size and that opening width of depressions and base width of projections are shown as being approximately equal, forming triangular shapes in section. Actually, the opening width of depressions and the base width of projections are not necessarily equal, and the sectional shape is not limited to triangular shapes. For example, the cross section of each depression (groove) may be substantially U-shaped and each projection may have a flat portion on top. Desirably, spacing of projections (center-to-center distance between tops of adjacent projections) in the projection/depression pattern 22 is 10 μm or less and the depth of the depressions in the projection/depression pattern 22 is such that a sufficient thickness can be secured for the nozzle plate. Specifically, the depth is 1 μm or less. The projection/depression pattern 22 can be formed in a self-organizing manner by laser irradiation. The laser can be, for example, a pulsed laser such as a femtosecond (1×10⁻¹⁵ sec (inclusive) to 1×10⁻¹² sec (exclusive)) laser, a picosecond (1×10⁻¹² sec (inclusive) to 1×10⁻⁹ sec (exclusive)) laser, or a nanosecond (1×10⁻⁹ sec (inclusive) to 1×10′ sec (exclusive)) laser. Specifically, a linearly-polarized laser is emitted at irradiation intensity in a neighborhood of a processing threshold and scanned by making irradiated regions overlap each other. The use of a pulsed laser allows plural grooves (depressions) to be processed simultaneously in an irradiation spot. That is, due to interference of incident light with scattered light or a plasma wave along a surface of the nozzle plate, a grating-shaped periodic structure (projection/depression structure) having spacing and depth on the order of a wave length can be formed orthogonally to a polarization direction in a self-organizing manner. In this way, the projection/depression pattern made up of projections and depressions disposed alternately at predetermined spacing is formed in a self-organizing manner on the liquid droplet ejection surface of the nozzle plate. Also, as the scanning is done by making irradiated regions overlap each other, the depressions can be processed by being joined together as grooves 32 as shown in FIG. 7A. Note that it is sufficient to move the laser irradiated regions relative to the nozzle plate, and the substrate may be placed on an X-Y stage or the like and moved with the laser fixed. After the groove-shaped projection/depression pattern is formed by the above method, scanning is done again by changing a polarization direction of the laser. Consequently, dot-shaped (i.e., moth-eye-shaped) projection/depression pattern 33 such as shown in FIG. 7B can be formed by forming grooves in another direction.

When the projection/depression pattern is made up of grooves 32 serving as depressions such as shown in FIG. 7A and furrows 31 serving as projections separated by the grooves, desirably an angle θ formed by an extension direction of the grooves and a wiping direction is between 0 degrees (inclusive) and 90 degrees (exclusive), and more desirably between 0 degrees (inclusive) and 45 degrees (exclusive). This is considered to be because the smaller the angle θ, the smaller the amount shaved by a wiping blade in forming the furrows 31 as projections by wiping, which keeps water repellency from decreasing. Note that the wiping direction is normally set to an arrangement direction of the ejection orifices 9 (first direction F) or a second direction S orthogonal to the arrangement direction, allowing the groove extension direction to be set with reference to the arrangement direction of the ejection orifices 9.

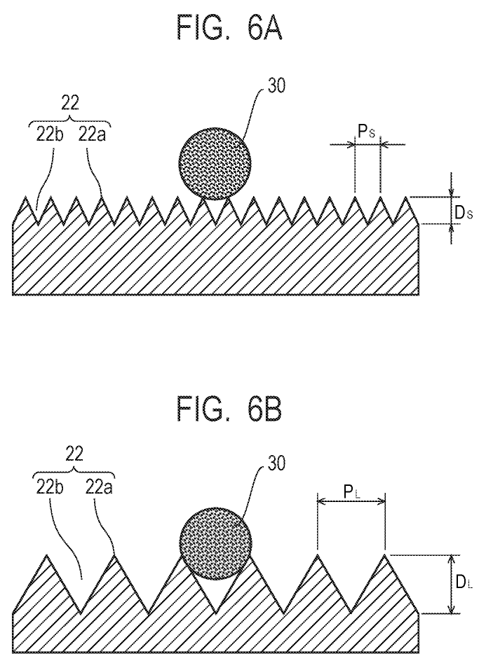

Also, the spacing of projections in the projection/depression pattern 22 can be controlled by an angle formed by a laser beam and nozzle plate surface. That is, when the laser beam is emitted at right angles to the nozzle plate surface, a period of the projection/depression pattern 22 (projection spacing) is the shortest and approximately coincides with wave length of the laser. When the laser beam is emitted at an inclined angle to the nozzle plate surface, the period of the projection/depression pattern 22 increases, and the larger the inclined angle (the smaller the angle of incidence to the substrate surface), the longer the period of the projection/depression pattern 22. The use of this phenomenon enables providing a region in which the period of the projection/depression pattern 22 on the nozzle plate changes stepwise or continuously using a laser beam of the same wave length. As shown in FIG. 6A, when the spacing (Ps) of the projections is sufficiently smaller than the size of the ink droplet 30, because the ink droplet 30 and projections 22a almost come into point contact with each other, high water repellency is exhibited (lotus effect) by the action of an air layer existing in the depression 22b. On the other hand, as shown in FIG. 6B, when the period of the projection/depression pattern 22 increases, because the ink droplet comes to fall into the depression 22b, air layer becomes relatively small, reducing the water repellency. Therefore, if the period of the projection/depression pattern 22 is changed by the above method, the water repellency on the nozzle plate can be sloped. Specifically, if the projection spacing is configured to be the narrowest in a neighborhood of the ejection orifice and to increase with increasing distance from the ejection orifice, the water repellency can be configured to be the highest in the neighborhood of the ejection orifice and decrease with increasing distance from the ejection orifice. This configuration allows the ink jet recording substrate to achieve the following advantageous effects.

Upon reaching the nozzle plate, each ink droplet moves on the nozzle plate by kinetic energy possessed by the ink droplet itself, inertial force generated by movement of the recording head, airflow produced by paper feed, and other forces. When the entire surface of the nozzle plate has high water repellency, because of small contact area between the ink droplets and nozzle plate, ink droplets will get detached from the nozzle plate, and attach to a printing object, presumably deteriorating print quality. Thus, as described above, the period of the projection/depression pattern is configured to be the shortest in the neighborhood of the ejection orifices and to increase with increasing distance from the ejection orifices. Consequently, if high water repellency is maintained by lotus effect in a region (which is referred to as a high-repellency region) in which adhesion of ejected ink droplets is desired to be inhibited and water repellency is reduced in another region (which is referred to as a low-repellency region), a moving direction of ink droplets can be kept at a fixed direction. That is, the ink droplets moving on the nozzle plate by being attached to the high-repellency region can be caught in the low-repellency region. With this configuration, any ink droplets attached to the neighborhood of ejection orifices do not stay there for a long time and can be caught in the low-repellency region that do not affect the ejection direction. As a result, the ink droplets that will affect the ejection direction by being located in the neighborhood of ejection orifices move quickly and are caught in the low-repellency region with limited impact on the ejection direction and without attaching to the printing object, which enables inhibiting deterioration in print quality.

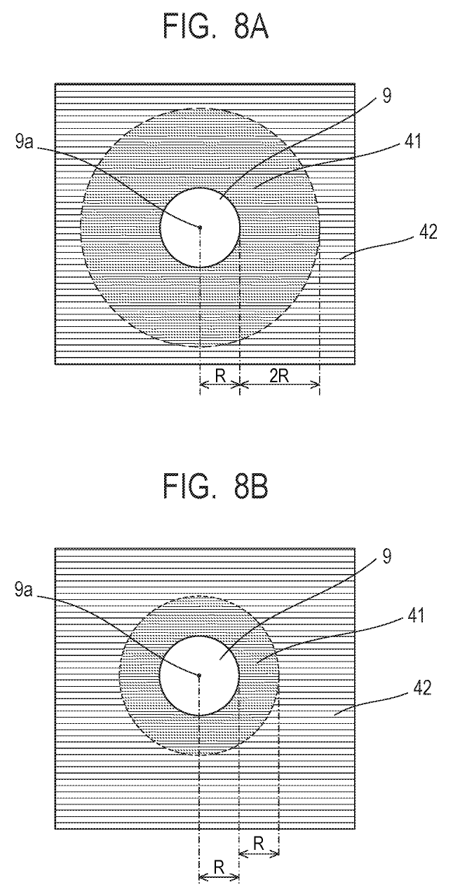

In this way, desirably the spacing of those projections in the projection/depression pattern that are formed up to a predetermined distance from the ejection orifice is smaller than the spacing of those projections in the projection/depression pattern that are formed beyond the predetermined distance from the ejection orifice. As shown in FIG. 8A, desirably the predetermined distance is a distance 2R from a contour of the ejection orifice 9, where the distance 2R is twice a maximum distance R from the center of gravity 9a of the opening of the ejection orifice 9 to the contour of the ejection orifice when the nozzle plate is seen in planar view. More desirably the predetermined distance is a distance R from the contour of the ejection orifice 9 as shown in FIG. 8B. Desirably the spacing of the projections in the projection/depression pattern in a region (high-repellency region 41) defined by the distance R is 1000 nm or less. On an outer side of the high-repellency region 41, there is a low-repellency region 42 in which ink droplets can be caught.

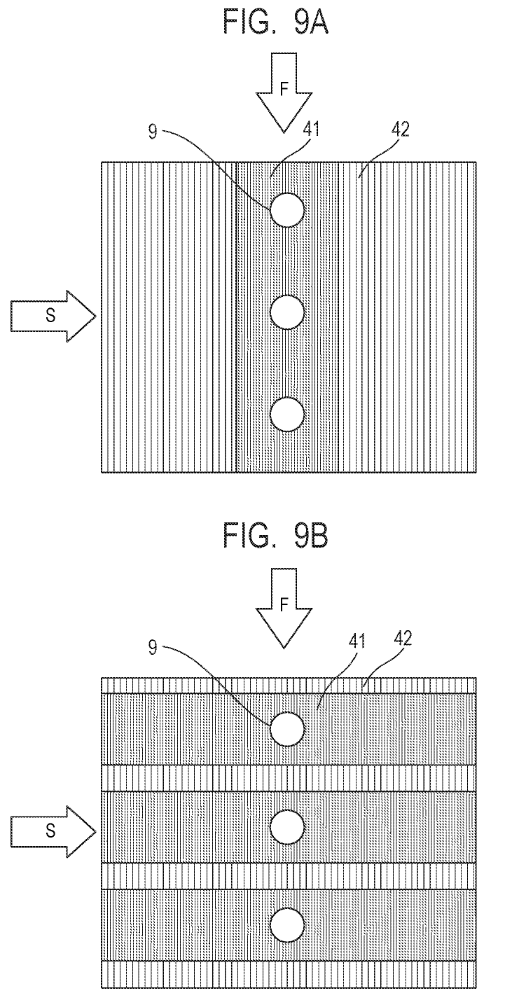

Note that actually, the contour of the high-repellency region 41 does not need to have a shape similar to the contour of the ejection orifice 9 and may extend in a direction irrelevant to movement of ink droplets. In FIGS. 9A and 9B, plural ejection orifices 9 are arranged in the first direction F and a direction orthogonal to the first direction F is designated as the second direction S. In FIG. 9A, the moving direction of ink droplets is the second direction S and the high-repellency region 41 is formed by extending in the first direction F. In FIG. 9B, the moving direction of ink droplets is the first direction F and the high-repellency region 41 is formed by extending in the second direction S.

Next, as shown in FIG. 4D, the ejection orifices 9 adapted to eject a liquid are formed in the nozzle plate 21. The ejection orifices 9 are formed for example, by etching the nozzle plate 21 by RIE or by irradiating the nozzle plate 21 with higher-intensity laser than in forming the projection/depression pattern. The ejection orifices 9 are formed in such a way as to penetrate the nozzle plate 21. When resist is applied in forming the ejection orifices 9, it may be difficult to form a resist layer due to the water repellency of the nozzle plate surface. In that case, a resist film can be formed by a technique such as spray coating or dry film application.

Next, the supply port 7 used to supply ink to the flow path is formed in the substrate 10. The supply port 7 is formed, for example, by irradiating the substrate 10 with laser or by anisotropically etching the substrate 10. Also, as shown in FIG. 4D, if a sacrificial layer 14 is formed beforehand in that region of the substrate 10 in which the supply port 7 is to be formed, an opening shape of the supply port 7 can be kept reliably in a predetermined range during anisotropic etching of the silicon substrate with an alkaline solution. If the coating layer 18 has been formed on the substrate 10, by removing the coating layer 18 from an opening portion of the supply port by ME, the substrate 10 is penetrated by the supply port 7. Note that the supply port 7 does not need to have been formed at this time. For example, the supply port 7 may be formed in the substrate beforehand at the stage of FIG. 4A. However, considering film formability of the mold 20 and the like, desirably the supply port 7 is formed after formation of the mold 20 and nozzle plate 21. Finally, the mold 20 is removed by isotropic dry etching or an appropriate solvent, thereby forming a liquid flow path 27. Part of the flow path 27 also serves as a liquid chamber 28 in which ejection energy is generated by energy generating elements.

An ink jet recording substrate that achieves the advantageous effects of the present invention can be produced whenever the projection/depression pattern 22 may be formed without being limited to the above step as long as the projection/depression pattern 22 is formed not before a film formation step for the layer designed to become the nozzle plate 21. However, desirably the step of forming the projection/depression pattern 22 and the step of removing the mold 20 are carried out in this order. This is because if one attempts to form the projection/depression pattern 22 after removing the mold 20, the coating layer 18 or protective layer 19 provided on the heat generating resistor 17 will also be irradiated with laser, which may affect ink droplet ejection characteristics.

The ink jet recording substrate according to the present embodiment shown in FIG. 3 is produced through the above steps.

The liquid ejection head substrate according to the present invention has a projection/depression pattern with even spacing and depth on the nozzle plate surface. Therefore, even if water repellency decreases with use, unintended variations in water repellency are less likely to occur on the nozzle plate. This enables preventing a liquid droplet ejection direction from wobbling, and thereby enables inhibiting deterioration in print quality more greatly than the conventional technique.

### EXAMPLES

The ink jet recording substrate according to the embodiment of the present invention will be described concretely below with reference to examples. The present invention is not limited to these examples.

### Example 1

A production process according to Example 1 of the present invention will be described below with reference to FIG. 3 and FIGS. 4A to 4D.

On a silicon substrate 10 on which driving elements such as transistors were provided, a thermally-oxidized layer 11 was formed to a thickness of 1 μm by thermally-oxidizing part of the substrate 10, and an aluminum layer was further formed as a sacrifice layer 14 in a location where a supply port was to be formed. Next, a heat accumulating layer 12 made of a silicon oxide film was formed to a thickness of 1 μm by plasma CVD. On the heat accumulating layer 12, a resistor layer 15 made of TaSiN (sheet resistance: 300 Ω/sq) and a film of aluminum alloy (Al—Cu; 1 μm) lower in resistance than the resistor layer 15 were formed continuously by a sputtering process. The resistor layer 15 and aluminum alloy were patterned by dry etching, forming an interconnect layer. Furthermore, aluminum alloy was removed by wet etching from a region designed to become the heat generating resistor 17 and a pair of electrode layers 16 were formed. By supplying a voltage between the pair of electrode layers 16, that part of the resistor layer 15 which was located between the pair of electrode layers 16 would be caused to generate heat and used as the heat generating resistor 17. Covering the heat generating resistor 17 and the pair of electrode layers 16, a 400-nm coating layer 18 made of SiN was deposited on an entire surface of a wafer by plasma CVD. Furthermore, a 300-nm tantalum film was formed by a sputtering process, covering the heat generating resistor 17 and patterned by dry etching, forming the protective layer 19. The structure shown in FIG. 4A was formed by the steps described so far.

Next, polyimide was spin-coated to a thickness of 20 μm, covering the heat generating resistor 17. Resist made of a photosensitive resin was applied to the formed polyimide film, exposed, and developed, forming a mask. Using the resist mask, the polyimide was etched by RIE, forming the mold 20 designed to become a pattern for the flow path 27. Next, a 10-μm layer of the nozzle plate 21 made of fluoridated DLC was formed by plasma CVD, covering the mold 20 from above. The structure shown in FIG. 4B was formed by the steps described so far.

Next, a surface of the layer designed to become the nozzle plate 21 was irradiated with a linearly-polarized femtosecond laser at energy density in the neighborhood of the processing threshold, thereby forming a grating-shaped projection/depression pattern 22.

In the projection/depression pattern 22 formed in this way, the spacing of the projections was approximately 700 nm and the depth of the depressions was approximately 200 nm. The structure shown in FIG. 4C was formed by the steps described so far. Note that in the projection/depression pattern 22, the depressions were groove-shaped while the projections were furrow-shaped. Also, the extending direction of the grooves and the wiping direction for wiping ink droplets off the nozzle plate surface were set to be parallel (forming an angle of 0 degrees). Note that the wiping direction was the first direction F in which an ejection orifice array was placed. Also, because the material itself of the fluoridated DLC film had water repellency, no additional water-repellent layer was provided.

Next, the ejection orifices 9 adapted to eject ink were formed in the layer designed to become the nozzle plate 21, and thus the nozzle plate 21 was formed (FIG. 4D). To form the ejection orifices 9, resist made of a photosensitive resin was spray-coated onto the layer designed to become the nozzle plate 21, exposed, developed, forming a mask, and then etched by RIE using the mask. Next, the supply port 7 was formed in the substrate 10. The supply port 7 was formed by anisotropically etching the silicon substrate 10 with a TMAH (tetramethylammonium hydroxide) solution. The coating layer 18 on the supply port 7 was removed by RIE to penetrate the supply port 7. Finally, the mold 20 was removed by isotropic dry etching (O₂ plasma ashing), which involved introducing oxygen gas and generating plasma for etching, and consequently the flow path 27 was formed. The structure shown in FIG. 3 was formed by the steps described so far.

The ink jet recording substrate created as described above was set on “MAXIFY (registered trademark) MB5330” (brand name) printer made by Canon, and 150000-sheet printing endurance test was conducted using A4-size sheets. As a result, no deterioration in print quality was recognized. Note that during the printing endurance test, wiping was done after every two sheets.

### Example 2

Next, Example 2 of the present invention will be described. In Example 1, the material itself of the nozzle plate 21 had water repellency. As shown in FIG. 5A, Example 2 differed from Example 1 only in that the substrate layer 23 of the nozzle plate 21 was not water-repellent and that the water-repellent layer 24 was provided as a surface layer of the nozzle plate 21. The rest of the configuration and production method were similar to those of Example 1, and thus description thereof will be omitted.

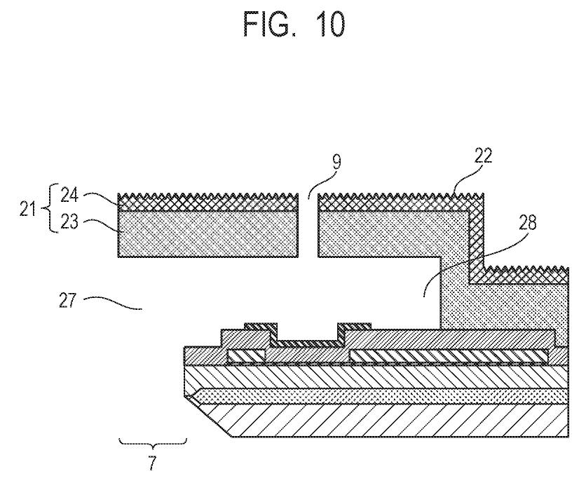

In Example 2, the substrate layer 23 of the nozzle plate 21 was formed by forming a film of silicon carbonitride (SiCN) 15 μm in thickness by plasma CVD. SiCN was not water-repellent. Next, a fluoridated DLC film 2 μm in thickness was formed as the water-repellent layer 24 on the substrate layer 23 by sputtering, and then as with Example 1, a surface of the water-repellent layer 24 was irradiated with a linearly-polarized femtosecond laser at energy density in the neighborhood of the processing threshold, thereby forming a grating-shaped projection/depression pattern 22. In the projection/depression pattern 22, the spacing of the projections was approximately 700 nm and the depth of the depressions was approximately 200 nm. This configuration allows a projection/depression pattern 22 with a water-repellent material on the outermost surface thereof to be formed on the surface of the nozzle plate 21 even when the material itself of the nozzle plate 21 does not have water repellency. Subsequently, the ink jet recording substrate was produced in the same manner as Example 1, and the structure shown in FIG. 10 was formed.

The ink jet recording substrate created as described above was subjected to a printing endurance test in the same manner as Example 1, and almost no deterioration in print quality was recognized.

### Example 3

Next, Example 3 of the present invention will be described. In Example 2, the projection/depression pattern 22 was formed by irradiating the water-repellent layer 24 formed on the substrate layer 23 with laser. Example 3 differed from Example 2 only in that a water-repellent layer 26 was formed after projections and depressions were formed on the substrate layer 25 itself. The rest of the configuration and production method were similar to those of Example 2, and thus description thereof will be omitted.

First, steps up to the step of forming the mold 20 of FIG. 4B were carried out in the same manner as in Example 1. As the substrate layer 25 of the nozzle plate 21, a film of silicon carbonitride (SiCN) 15 μm in thickness was formed by plasma CVD. SiCN was not water-repellent. Next, a surface of the substrate layer 25 was irradiated with a linearly-polarized femtosecond laser at energy density in the neighborhood of the processing threshold, thereby forming a grating-shaped projection/depression pattern 22.

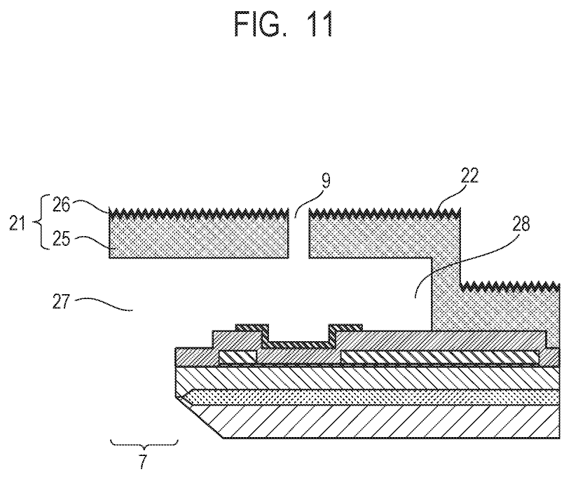

In the projection/depression pattern 22, the spacing was approximately 700 nm and the depth was approximately 200 nm. Next, a fluorine resin was spray-coated onto the projection/depression pattern 22, thereby forming a water-repellent layer 26 with a thickness of 5 nm. Regarding the fluorine resin, one that can form a monomolecular film is used suitably, and grooves are not buried when surplus resin adhering along the projection/depression pattern, i.e., resin other than the monomolecular film, is removed by washing or the like. This configuration allows a projection/depression pattern 22 with a water-repellent material on the outermost surface thereof to be formed on the surface of the nozzle plate 21 even when the substrate layer (material for forming the substrate layer) itself of the nozzle plate 21 does not have water repellency. Subsequently, the ink jet recording substrate was produced in the same manner as Example 1, and the structure shown in FIG. 11 was formed.

The ink jet recording substrate created as described above was subjected to a printing endurance test in the same manner as Example 1, and almost no deterioration in print quality was recognized.

### Example 4

Next, Example 4 of the present invention will be described. In this example, description will be given of how deterioration in print quality is affected by an angle (hereinafter referred to as θ) formed by a direction of grooves in the projection/depression pattern 22 formed on the nozzle plate 21 and the wiping direction for wiping ink droplets attached to the surface of the nozzle plate 21 during use. The direction of grooves in the projection/depression pattern 22 can be controlled by a polarization direction of the laser. This example differed from Example 3 only in the polarization direction of the laser used to form the projection/depression pattern 22. The rest of the configuration and production method were similar to those of Example 3, and thus description thereof will be omitted.

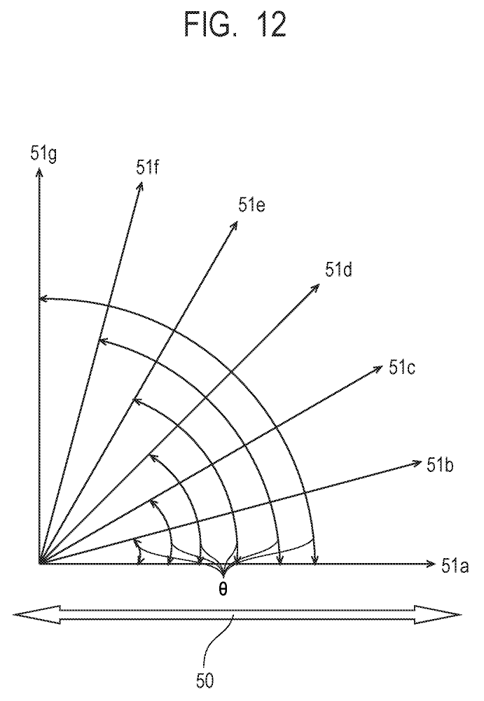

In Example 4, ink jet recording substrates with θ of between 0 and 90 degrees were created by varying the polarization direction of the laser for irradiation. FIG. 12 is a schematic plan view showing a relationship between a wiping direction 50 and a direction 51 of grooves, where seven directions (51a to 51g) are provided by changing θ at intervals of 15 degrees. The direction of 0 degrees (51a) is parallel to the wiping direction and the direction of 90 degrees (51g) is orthogonal to the wiping direction.

The ink jet recording substrate created as described above was subjected to a printing endurance test in the same manner as Example 1. When the angle θ was from 0 degrees to 45 degrees, almost no deterioration in print quality was recognized even after 150000 sheets of printing. When the angle θ was 60 degrees or 75 degrees, almost no deterioration in print quality was recognized after 100000 sheets of printing, but deterioration in print quality was recognized after 150000 sheets of printing. Also, when the angle θ was 90 degrees, deterioration in print quality was recognized before reaching 100000 sheets of printing. When the head was analyzed after the test, it was found that the water-repellent layer decreased with increases in the angle θ. Results of the test are summarized in Table 1.

TABLE 1

| | Angle θ | | | | | | |
|---|---|---|---|---|---|---|---|
| | 0 de- | 15 de- | 30 de- | 45 de- | 60 de- | 75 de- | 90 de- |
| | grees | grees | grees | grees | grees | grees | grees |
| Print | A | A | A | A | B | B | C |
| Quality | | | | | | | |

A: Almost no deterioration in print quality even after 150000 sheets of printing
B: Almost no deterioration in print quality even after 100000 sheets of printing
C: Deterioration in print quality before reaching 100000 sheets of printing

### Example 5

Next, Example 5 of the present invention will be described. In Example 5, description will be given of a case in which the period of the projection/depression pattern 22 is changed on the nozzle plate 21. Note that the ink jet recording substrate used in Example 5 differed from Example 1 only in a laser irradiation method. The rest of the configuration and production method were similar to those of Example 1, and thus description thereof will be omitted.

The spacing of the projections making up the projection/depression pattern 22 can be controlled by an angle formed by the laser beam and the surface of the nozzle plate 21. That is, the spacing of the grooves is the narrowest when the laser beam is emitted at right angles to the nozzle plate 21 and approximately coincides with the wave length of the laser. When the laser beam is emitted at an inclined angle to the nozzle plate, the spacing of the grooves increases, and the larger the angle, the larger the spacing of the grooves. Using this phenomenon, in this example, by scanning a laser of the same wave length while changing an irradiation angle, the projection/depression pattern 22 was formed such that the spacing of the projections would be narrow in a neighborhood of the ejection orifices 9, increasing with increasing distance from the ejection orifices 9. More specifically, the high-repellency region 41 was formed by emitting the laser at right angles to the nozzle plate 21 in the neighborhood of the ejection orifices 9 and the low-repellency region 42 was formed by decreasing the angle of incidence of the laser with increasing distance from the ejection orifices 9. The nozzle plate surface of the ink jet recording substrate created in this way is shown in FIG. 9A.

The spacing of the projection/depression pattern 22 was classified into levels A to C as follows. At level A, a region covering the distance R corresponding to a radius R of the ejection orifice from the contour of the ejection orifice 9 was a high-repellency region 41 in which the spacing of the projections was approximately 700 nm and groove depth was approximately 200 nm. A region further away from the ejection orifice 9 was a low-repellency region 42 in which the spacing of the projections was approximately 2000 nm and groove depth was approximately 600 nm. At level B, a region covering the distance 2R corresponding to a diameter of the ejection orifice 9 from an edge of the ejection orifice 9 was a high-repellency region 41 and a region on an outer side thereof was a low-repellency region 42. At level C, the projection spacing in the neighborhood of the ejection orifice 9 was approximately 700 nm and groove depth was approximately 200 nm. The projection spacing increased gradually with increasing distance from the ejection orifice 9. At the edge of the projection/depression pattern, the projection spacing was approximately 2000 nm and groove depth was approximately 600 nm. Note that at level C, scanning was done by changing the laser irradiation angle and there was no clear boundary between the high-repellency region 41 and low-repellency region 42.

The ink jet recording substrate created as described above was subjected to a printing endurance test in the same manner as Example 1, and almost no deterioration in print quality was recognized at any of the levels. When the nozzle plate surface was observed after the printing endurance test, adhesion of ink droplets was found in locations away from the ejection orifices, but almost no adhesion of ink droplets was found in the neighborhood of the ink ejection orifices.

The printing endurance test was continued to check relative superiority among the levels, and deterioration in print quality was observed in the order: in level C, level A, and level B.

The present invention, which can form a projection/depression structure with even spacing and depth at a desired position unlike the conventional technique, enables preventing a liquid droplet ejection direction from wobbling due to variations in water repellency resulting from changes in water repellency with use. Thus, the present invention provides a liquid ejection head substrate that can inhibit deterioration in print quality more greatly than the conventional technique.

### COMPARATIVE EXAMPLE

In a comparative example, a projection/depression pattern 22 on the nozzle plate 21 was formed by rubbing. The comparative example differed from Example 1 only in that the projection/depression pattern 22 on the nozzle plate 21 was formed by rubbing. The rest of the configuration was similar to that of Example 1, and thus description thereof will be omitted. Cotton velvet cloth was used for the rubbing. Compared to Example 1, the projection/depression pattern 22 was formed randomly, the spacing of projections was distributed in a range of 10 nm to 1 μm, and the depression depth was dispersed. When 100000 sheets were printed as with Example 1 using an ink jet recording substrate created in this way, there were variations in the ejection direction of ink droplets and deterioration in print quality was recognized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-034903, filed Feb. 28, 2018, which is hereby incorporated by reference herein in its entirety.

What is claimed is:

1. A liquid ejection head substrate comprising a nozzle plate provided with an ejection orifice adapted to eject liquid droplets, wherein:
a projection/depression pattern is provided on a liquid droplet ejection surface of the nozzle plate, the projection/depression pattern being made up of a plurality of projections and depressions, the projections being separated by depressions 1 μm or less in depth and disposed at predetermined spacing 10 μm or less in length; and
the projection/depression pattern includes a part having water repellency due to lotus effect.

2. The liquid ejection head substrate according to claim 1, wherein: a plurality of the ejection orifices makes up an ejection orifice array by being arranged in a first direction; the projection/depression pattern is made up of grooves serving as depressions and furrows serving as projections separated by the grooves; and an angle formed by the first direction and an extension direction of the grooves is between 0 degrees inclusive and 90 degrees exclusive

3. The liquid ejection head substrate according to claim 2, wherein the angle formed by the first direction and the extension direction of the grooves is in a range of between 0 degrees and 45 degrees both inclusive.

4. The liquid ejection head substrate according to claim 1, wherein spacing of those projections in the projection/depression pattern that are formed up to a predetermined distance from a contour of the ejection orifice is smaller than the spacing of those projections in the projection/depression pattern that are formed beyond the predetermined distance from the ejection orifice.

5. The liquid ejection head substrate according to claim 4, wherein if R is a maximum distance from a center of gravity of an opening of the ejection orifice to the contour of the ejection orifice when the nozzle plate is seen in planar view, the spacing of those projections in the projection/depression pattern in a region from the contour of the ejection orifice up to a distance of 2R is 1000 nm or less.

6. The liquid ejection head substrate according to claim 4, wherein if R is a maximum distance from a center of gravity of an opening of the ejection orifice to the contour of the ejection orifice when the nozzle plate is seen in planar view, the spacing of those projections in the projection/depression pattern in a region from the contour of the ejection orifice up to a distance of R is 1000 nm or less.

7. The liquid ejection head substrate according to claim 5, wherein the spacing of those projections in the projection/depression pattern that are formed beyond the predetermined distance increases with increasing distance from the ejection orifice.

8. The liquid ejection head substrate according to claim 1, wherein a liquid droplet ejection surface of the nozzle plate is made of an inorganic material.

9. The liquid ejection head substrate according to claim 1, wherein the nozzle plate has a laminated structure made up of a first material and a second material higher in water repellency than the first material and the liquid droplet ejection surface is made of the second material.

10. A method for producing a liquid ejection head substrate that includes a nozzle plate provided with an ejection orifice adapted to eject liquid droplets, the method comprising emitting a linearly-polarized laser to a liquid droplet ejection surface of the nozzle plate at irradiation intensity in a neighborhood of a processing threshold and thereby forming a projection/depression pattern in a self-organizing manner on the liquid droplet ejection surface of the nozzle plate, the projection/depression pattern being made up of projections and depressions disposed alternately at predetermined spacing.

11. The method according to claim 10, wherein a pulsed laser is used as the laser.

12. The method according to claim 11, wherein a femtosecond laser is used as the pulsed laser.

13. The method according to claim 10, wherein forming the projection/depression pattern in a self-organizing manner moves laser irradiated regions relative to the nozzle plate while making the laser irradiated regions overlap each other, and thereby forms the projection/depression pattern made up of grooves serving as depressions and furrows serving as projections separated by the grooves; and controls a polarization direction of the laser such that an angle formed by a wiping direction during use of the liquid ejection head substrate and an extension direction of the grooves is between 0 degrees inclusive and 90 degrees exclusive.

14. The method according to claim 13, wherein a polarization direction of the laser is controlled such that the angle formed by the wiping direction and the extension direction of the grooves is in a range of between 0 degrees and 45 degrees both inclusive.

15. The method according to claim 10, wherein forming the projection/depression pattern in a self-organizing manner includes: emitting the laser perpendicularly to the nozzle plate in a region from a contour of the ejection orifice up to a predetermined distance; and emitting the laser obliquely to the nozzle plate in a region beyond the predetermined distance from the ejection orifice.

16. The method according to claim 10, further comprising making the liquid droplet ejection surface of the nozzle plate from a water-repellent inorganic material and forming the projection/depression pattern on the inorganic material.

17. The method according to claim 16, wherein the nozzle plate has a laminated structure made up of a first material and a second material higher in water repellency than the first material and the liquid droplet ejection surface is made of the second material.

18. The method according to claim 10, further comprising making the liquid droplet ejection surface of the nozzle plate from a non-water-repellent inorganic material; and forming the projection/depression pattern on the inorganic material and then forming a water-repellent film along a shape of the projection/depression pattern.

19. The method according to claim 10, further comprising forming the ejection orifice after forming the projection/depression pattern in a self-organizing manner.

20. The method according to claim 11, further comprising forming the ejection orifice after forming the projection/depression pattern in a self-organizing manner.
